(19) United States
(12) Patent Application Publication
(10) Pub. No.: US 2019/0300257 A1
(43) Pub. Date: Oct. 3, 2019

(54) PACKAGING FOR FOODS

(71) Applicant: INDUSTRIE ROLLI ALIMENTARI S.P.A., Roseto Degli Abruzzi (IT)

(72) Inventor: Gian Paolo ROLLI, Roseto Degli Abruzzi (IT)

(21) Appl. No.: 16/307,388

(22) PCT Filed: Jun. 14, 2016
(86) PCT No.: PCT/IT2016/000154

§ 371 Date: Dec. 5, 2018

(51) Int. Cl. B65D 77/04; B65D 81/34; A23L 3/36

(52) U.S. Cl. CPC B65D 77/04; B65D 81/3453; B65D 81/3461; A23L 3/36; A23V 2002/00; B65D 2581/3404; B65D 2581/3416; B65D 2581/3406; B65D 2203/02

(57) ABSTRACT

A packaging for foods includes a container within which at least two enclosures are inserted. Each enclosure is configured to contain a different type of frozen prepared food product. The food product is preferably chosen from among a first course, a second course, a side dish, an oven-baked product and the like.

### TECHNICAL FIELD

The present disclosure relates to a packaging for foods.

### BACKGROUND

It is known that the dietary habits and consumption models of individuals have changed considerably in recent years, influenced by various different factors such as for example an ever-increasing attention to costs, limited time to spend on preparing meals, and increasing attention paid to the healthfulness of the products consumed as well as the impact that their production, their packaging and their consumption can have on the environment.

In particular, the consumption of ready-made products has increased, particularly both in the collective catering trade (canteens, schools, hospitals and the like) and in the large-scale retail trade.

Technological development has therefore been directed at providing packages for foods of various sizes which are capable of preserving a single type of food (first courses, second courses, fruit, soup and the like) which are preserved both at ambient temperature, and at the temperature of −18° C., in order to then be reheated in an oven or in a microwave oven, while keeping the organoleptic and nutritional characteristics of the products contained therein intact.

For such reasons the search for food products that can meet the various different requirements of the consumer is being increasingly intensified.

### SUMMARY

The aim of the present disclosure is to solve the above mentioned drawbacks, by providing a packaging for foods the contents of which constitute a complete meal.

Within this aim, the disclosure provides a packaging for foods that are easy to prepare and consume.

The disclosure provides a packaging for foods that safeguards the organoleptic and nutritional properties of the food product contained therein.

The present disclosure also provides a packaging for foods that is low cost, easily and practically implemented and safe in use.

This aim and these and other advantages which will become better apparent hereinafter are achieved by providing a packaging for foods, characterized in that it comprises a container within which at least two enclosures are inserted, each enclosure being intended to contain a different type of frozen prepared food product, said food product being of the type preferably chosen from among a first course, a second course, a side dish, an oven-baked product and the like.

### DETAILED DESCRIPTION OF THE DISCLOSURE

Further characteristics and advantages of the disclosure will become better apparent from the description of a preferred, but not exclusive, embodiment of the packaging for foods, according to the disclosure.

Such package comprises a container within which at least two enclosures are inserted.

Each enclosure is intended to contain a different type of frozen prepared food product.

Such food product is of the type preferably chosen from among a first course, a second course, a side dish, an oven-baked product and the like.

Therefore the consumer by way of the purchase of a single packaging for foods, according to the disclosure, can have different food products available, the set of which effectively constitutes a complete meal.

In particular, the food product can be a preset portion size according to standards corresponding to the needs of at least one adult consumer.

The packaging for foods can have different sizes according to whether it is intended to contain food products in single-portion size or in a bigger portion size, in order to meet the requirements of a couple, a family of three and the like.

According to a solution of particular utility and practicality, the container can be a box-like body.

Such box-like body can have surface images of the type of wordings, logos, photographs, brands and the like.

The product information for example can be given directly on the box-like body.

According to a solution of particular effectiveness and efficiency, the enclosure can be a bag intended to contain a frozen prepared food product.

It should be noted that such bag can contain a tub inside which a frozen prepared food product will be preserved.

It should be noted that such tub can be made of a microwave-resistant material.

It will therefore be possible for the consumer to perform the cooking of such food product in a skillet or by way of a traditional or microwave oven.

If cooking by way of a microwave oven is used, it should be noted that such tub, being microwave-safe, can also be used as a cooking vessel and optionally as a plate from which to consume the food product contained in it after microwaving, thus simplifying and optimizing the entire process of using the food product.

It should further be noted that the food product does not require a period of slow defrosting in the refrigerator or at ambient temperature, but can be immediately introduced into the microwave oven.

In particular, the first course can comprise an element chosen from among long pasta, short pasta, rice, barley and the like, with a condiment of the type preferably chosen from among a ketchup, a sauce and the like.

Furthermore, the second course can be of the type preferably chosen from among a second course of meat, a second course of fish and the like.

The side dish can comprise at least one element chosen from among garlic, asparagus, basil, beet leaves, broccoli, artichokes, carrots, cauliflower, chicory, turnip greens, onion, chickpeas, string beans, Borlotti beans, green beans, broad beans, fennel, lentils, eggplant, bell peppers, potatoes, peas, tomatoes, scallions, parsley, celery, endives, spinach, savoy cabbage, pumpkin and zucchini, with a condiment of the type preferably chosen from among oil, vinegar, salsa, spices and the like.

The use of salt or other condiments can be left to the discretion of the consumer and can be added when cooking is complete.

The oven-baked product can be of the type preferably chosen from among bread, focaccia, pizza and the like.

According to a preferred solution the box-like body can contain two bags.

The first bag will contain a frozen oven-baked product, while the second bag can contain a tub inside which a precooked and frozen first course will be preserved.

In order to make clear which food products the package according to the disclosure can contain, below are some examples of the types of product that can be produced.

It should be noted that such examples are given solely for the purposes of illustration and cannot therefore be considered applicable to a limitation of the scope of protection of the present disclosure.

### EXAMPLE 1

The package comprises a box-like body containing two bags.

The first bag contains a baked and frozen cheese and tomato pizza, while the second bag contains a tub inside which a pre-cooked and frozen portion of pasta, dressed with carbonara and ham sauce, is preserved.

### EXAMPLE 2

The package comprises a box-like body containing two bags.

The first bag contains a baked and frozen garlic focaccia, while the second bag contains a tub inside which a pre-cooked and frozen portion of pasta, dressed with ground meat sauce, is preserved.

Advantageously, the packaging for foods contains a food product that constitutes a complete meal.

Effectively, the packaging for foods is easy to prepare and consume.

Conveniently, the package according to the disclosure safeguards the organoleptic and nutritional properties of the food product contained therein.

The disclosure, thus conceived, is susceptible of numerous modifications and variations, all of which are within the scope of the appended claims

Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

1-10. (canceled)

11. A packaging for foods, comprising a container within which at least two enclosures are inserted, each enclosure configured to contain a different frozen prepared food product, said food product being chosen from among a first course, a second course, a side dish, and an oven-baked product.

12. The packaging for foods according to claim 11, wherein said food product is in a preset portion size according to standards corresponding to the needs of at least one adult consumer.

13. The packaging for foods according to claim 11, wherein said container is a body, and said container has surface images of the type of wordings, logos, photographs, and brands.

14. The packaging for foods according to claim 11, wherein said enclosure is a bag intended to contain a frozen prepared food product.

15. The packaging for foods according to claim 11, wherein said bag contains a tub inside which a frozen prepared food product is preserved, said tub being made of microwave-resistant material.

16. The packaging for foods according to claim 11, wherein said first course comprises an element chosen from among long pasta, short pasta, rice, barley and the like, with a condiment.

17. The packaging for foods according to claim 11, wherein said second course is of the type chosen from among a second course of meat, a second course of fish and the like.

18. The packaging for foods according to claim 11, wherein said side dish comprises at least one element chosen from among garlic, asparagus, basil, beet leaves, broccoli, artichokes, carrots, cauliflower, chicory, turnip greens, onion, chickpeas, string beans, Borlotti beans, green beans, broad beans, fennel, lentils, eggplant, bell peppers, potatoes, peas, tomatoes, scallions, parsley, celery, endives, spinach, savoy cabbage, pumpkin and zucchini, with a condiment chosen from among oil, vinegar, salsa, spices and the like.

19. The packaging for foods according to claim 11, wherein said oven-baked product is chosen from among bread, focaccia, pizza and the like.

20. The packaging for foods according to claim 11, wherein said body contains two bags, said first bag containing a frozen oven-baked product, said second bag containing a tub inside which a precooked and frozen first course is preserved.
